(19) United States
(12) Patent Application Publication
(10) Pub. No.: US 2019/0351627 A1
(43) Pub. Date: Nov. 21, 2019

(54) METHOD FOR MANUFACTURING MULTILAYER FIBER REINFORCED RESIN COMPOSITE AND MOLDED PRODUCT USING THE SAME

(71) Applicants: Hyundai Motor Company, Seoul (KR); Kia Motors Corporation, Seoul (KR)

(72) Inventor: Won Ki SONG, Seongnam-si (KR)

(73) Assignees: Hyundai Motor Company, Seoul (KR); Kia Motors Corporation, Seoul (KR)

(21) Appl. No.: 16/169,791

(22) Filed: Oct. 24, 2018

(30) Foreign Application Priority Data
May 17, 2018 (KR) 10-2018-0056392

(51) Int. Cl. B29C 70/20; B29C 70/32; B29C 70/34; B29D 23/00

(52) U.S. Cl. CPC B29C 70/202; B29C 70/32; B29L 2009/00; B29D 23/001; B29C 70/345

(57) ABSTRACT

A method for manufacturing a multilayer fiber reinforced resin composite, may include preparing a multi-sheet connected by sequentially disposing and connecting a plurality of reinforced fiber sheets, in which reinforced fibers are prepared in different arrangement directions, in a longitudinal direction thereof; rolling the multi-sheet to prepare a pipe-shaped multi-core having a plurality of layers; and impregnating the multi-core with a resin.

### CROSS REFERENCE TO RELATED APPLICATION

The present application claims priority to Korean Patent Application No. 10-2018-0056392, filed May 17, 2018, the entire contents of which is incorporated herein for all purposes by this reference.

### BACKGROUND OF THE INVENTION

### Field of the Invention

The present invention relates to a method for manufacturing a multilayer fiber reinforced resin composite and a molded product using the same, and more particularly, to a method for manufacturing a multilayer fiber reinforced resin composite in which a stacked structure is realized by a rolling process without a stacking process, and a molded product using the same.

### Description of Related Art

Conventionally, it has been common to manufacture vehicle body structures and various parts of vehicles using a steel material. Recently, a composite material such as a fiber reinforced resin composite is used as a substitute of the steel material to enhance fuel efficiency in accordance with a reduction in weight.

A basic structure of a fiber-reinforced resin composite may include a reinforcement playing a role of being responsible for a load added to a material and a basic material combined with the reinforcement to realize an overall shape of the material and serving to transferring the load applied to the material to the reinforcement. Here, as the reinforcement, fibrous reinforcements such as carbon fiber, glass fiber, aramid fiber, and the like, are commonly used, and, as the base material, a resin type base material such as a thermosetting resin including a phenol resin, an epoxy resin, and the like, or a thermoplastic resin including polyvinyl chloride (PVC), polyethylene (PE), polypropylene (PP), and the like, is commonly used.

Such a fiber reinforced resin composite may be manufactured by various methods depending on selection of reinforcements or base materials, such as pultrusion which continuously produces products having a predetermined shape by impregnating a fiber yarn with a resin in a die, a resin transfer molding (RTM) method of supplying a reinforcement in a woven state into a mold and impregnating the reinforcement with a resin, and a reaction injection molding (RIM) method of directly polymerizing a resin in a mold, and the like.

Meanwhile, fibrous reinforcements used as reinforcements are classified into short fibers, long fibers, and continuous fibers according to lengths thereof, and among them, the continuous fibers differ in manifested physical properties according to arrangement directions thereof. In recent years, to obtain more improved physical properties by utilizing the anisotropic properties according to the arrangement directions of fibers, reinforcements in a woven state having different arrangement directions are stacked in a desired arrangement direction to be used.

As for a method for manufacturing a multilayer fiber reinforced resin composite, reinforced sheets in specific arrangement directions are prepared by impregnating fiber sheets in a woven fabric state woven in different arrangement directions with a resin, and the thusly prepared reinforcing sheets are stacked in desired arrangement directions and bonded to be used.

However, such a multilayer fiber reinforced resin composite has disadvantages in that dispersion occurs in a process of bonding the respective layers and defective bonding occurs in each region.

Furthermore, continuity between the reinforced fibers forming each layer of the fiber-reinforced resin composite is cut off, and there is a limitation in realizing a block-shaped product, rather than a plate shaped-product.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method for manufacturing a multilayer fiber reinforced resin composite in which a stacked structure is realized by a rolling process without a stacking process of reinforced fibers disposed in different directions, and a molded product using the same.

According to an exemplary embodiment of the present invention, a method for manufacturing a multilayer fiber reinforced resin composite may include: preparing a multi-sheet by sequentially disposing and connecting a plurality of reinforced fiber sheets, in which reinforced fibers are prepared in different arrangement directions, in a longitudinal direction thereof; rolling the multi-sheet to prepare a pipe-shaped multi-core having a plurality of layers; and impregnating the multi-core with a resin.

In the preparing of the multi-sheet, the plurality of reinforced fiber sheets may be sequentially disposed in the longitudinal direction on the same plane and continuously connected.

In the preparing of the multi-sheet, the multi-sheet may be prepared by connecting end portions of the plurality of adjacent reinforced fiber sheets in which reinforced fibers are woven in different arrangement directions. Here, the end portions of the adjacent reinforced fiber sheets may be overlapped by a predetermined length and an overlap section may be stitched to connect the end portions of the adjacent reinforced fiber sheets.

In the preparing of the multi-sheet, the multi-sheet may be prepared by continuously weaving the reinforced fibers to have different arrangement direction by regions. Here, the reinforced fibers may be continuously woven, while changing weaving directions thereof to have different arrangement patterns by regions using a tailored fiber placement (TFP) facility.

In the preparing of the multi-core, a plurality of layers may be formed by continuously winding the multi-sheet on an external circumferential surface of an internal mold rotating about a rotation axis.

A length of each of the reinforced fiber sheets in the preparing of the multi-sheet may be determined to correspond to the perimeter of an external circumferential surface of the internal mold used in the preparing of the multi-core.

A length of each of the reinforced fiber sheets in the preparing of the multi-sheet may be determined as a length of a multiple of the perimeter of an external circumferential surface of the internal mold used in the preparing of the multi-core.

The preparing of the multi-core may include preparing a pair of internal molds, disposing the internal molds at both end portions of the multi-sheet, respectively, and subsequently rolling the pair of internal molds toward a center portion of the multi-sheet to allow the multi-sheet to be wound on an external circumferential surface of each of the internal molds, as a plurality of layers.

The impregnating may include disposing the multi-core in a cavity prepared by combining an upper mold and a lower mold and injecting a resin into the cavity to impregnate the multi-core with the resin.

According to an exemplary embodiment of the present invention, a molded product manufactured by a method for manufacturing a multilayer fiber reinforced resin composite may include: a multi-core formed by rolling a multi-sheet, which is formed by sequentially disposing and continuously connecting a plurality of reinforced fiber sheets, in which reinforced fibers are prepared in different arrangement directions, in a longitudinal direction thereof, in a pipe shape having a plurality of layers, wherein the multi-core is impregnated with a resin.

The multi-core may be formed by rolling the multi-sheet from one end portion thereof in a direction of the other side thereof in a pipe shape.

The multi-core may include a pair of continued roll portions formed by rolling the multi-sheet from both end portions thereof in a direction toward a center portion thereof.

The internal to the multi-core may have a hollow portion in a width direction of the multi-sheet.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a method for manufacturing a multilayer fiber reinforced resin composite according to an exemplary embodiment of the present invention;

FIG. 2 is a cross-sectional view of a molded product manufactured by a method for manufacturing a multilayer fiber reinforced resin composite according to an exemplary embodiment of the present invention;

FIG. 3A and FIG. 3B illustrate a method for preparing a multi-sheet according to an exemplary embodiment of the present invention;

FIG. 4 and FIG. 5 are views illustrating a method for manufacturing a back beam for a vehicle by a method for manufacturing a multilayer fiber reinforced resin composite according to an exemplary embodiment of the present invention; and

FIG. 6A and FIG. 6B are views illustrating a back beam for a vehicle manufactured by a method for manufacturing a multilayer fiber reinforced resin composite according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Hereinafter, embodiments of the present invention will be described in detail with reference to the accompanying drawings. The present invention may, however, be embodied in different forms and should not be construed as limited to the exemplary embodiments set forth herein. Rather, these embodiments are provided so that the present disclosure will be thorough and complete, and will fully convey the scope of the present invention to those skilled in the art. Throughout the specification, like numbers refer to like elements.

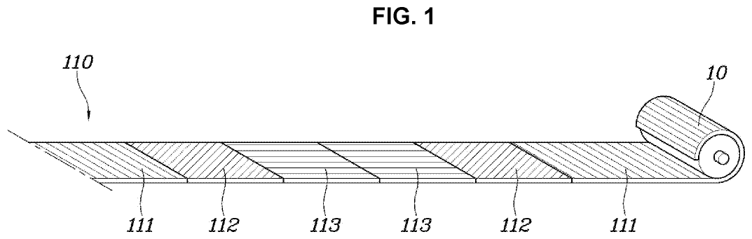

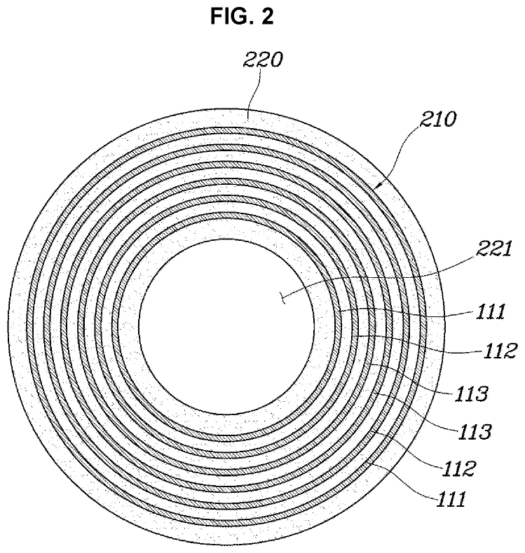

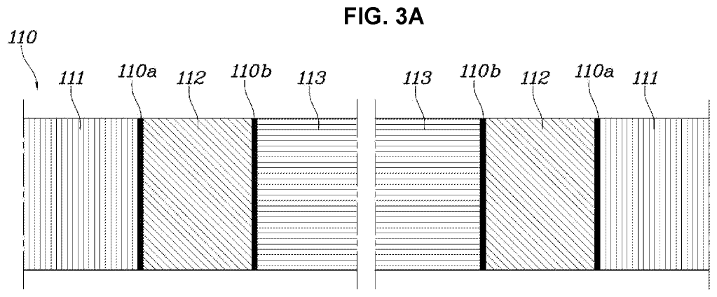

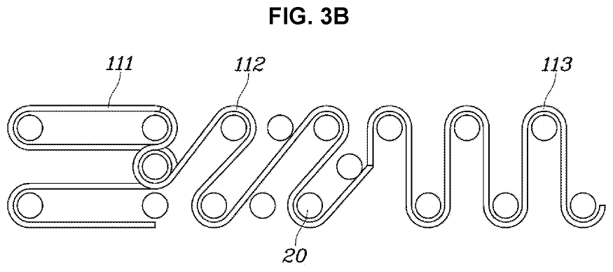

FIG. 1 is a view illustrating a method for manufacturing a multilayer fiber reinforced resin composite according to an exemplary embodiment of the present invention, FIG. 2 is a cross-sectional view of a multilayer fiber reinforced resin composite according to an exemplary embodiment of the present invention, and FIG. 3A and FIG. 3B are views illustrating a method for preparing a multi-sheet according to an exemplary embodiment of the present invention.

As illustrated in the drawings, a method for manufacturing a multilayer fiber reinforced resin composite according to an exemplary embodiment of the present invention includes a step of forming a multi-sheet 110 connecting a plurality of reinforced fiber sheets 111, 112, and 113, rolling the multi-sheet 110 to prepare a pipe-shaped multi-core 210 having a plurality of layers; and impregnating the multi-core 210 with a resin 120.

The step of preparing the multi-sheet is a step of preparing the multi-sheet 110 having different arrangement directions by regions in a longitudinal direction thereof. For example, a plurality of reinforced fiber sheets 111, 112, and 113 in which reinforced fibers disposed regularly at any one angle among 0°, ±45°, and ±90° are woven may be sequentially disposed in the longitudinal direction on the same plane to form the successively connected multi-sheet 110.

Here, the specific process of preparing the multi-sheet 110 may be implemented by various methods.

For example, as illustrated in FIG. 3A, to prepare the multi-sheet 110, first, a first reinforced fiber sheet 111 in which reinforced fibers are woven at 0°, a second reinforced fiber sheet 112 in which reinforced fibers are woven at 45°, and a third reinforced fiber sheet 113 in which reinforced fibers are woven at 90° are individually prepared. As such, the first reinforced fiber sheet 111, the second reinforced fiber sheet 112 and the third reinforced fiber sheet 113 are selectively disposed in the longitudinal direction successively and then connected. Here, end portions of the reinforced fiber sheets 111, 112, and 113 disposed adjacent to each other overlap each other by a predetermined length to form overlapping sections 110a and 110b. The overlapping sections 110a and 110b are stitched to successively connect the reinforced fiber sheets 111, 112, and 113 adjacent to each other. Here, the first reinforced fiber sheet 111, the second reinforced fiber sheet 112, and the third reinforced fiber sheet 113 are not limited to the illustrated arrangement angles but may be implemented at various other angles and the number and arrangement order of the reinforced fiber sheets may also be variously modified.

As illustrated in FIG. 3B, a tailored fiber placement (TFP) facility including a plurality of constraining pins 20 is used to provide the multi-sheet 110. Accordingly, reinforced fibers are successively woven to have different arrangement directions by regions. Here, weaving is continuously performed while changing a weaving direction by regions to have different arrangement patterns by regions. For example, at an early stage of weaving, reinforced fibers are woven at 0° to form the first reinforced fiber sheet 111, woven at 45° to form the second reinforced fiber sheet 112, and subsequently woven at 90° to form the third reinforced fiber sheet 113 to prepare the multi-sheet 110 continuously connected in different arrangement directions by regions. Also, in the instant case, the reinforced fiber sheets are not limited to the illustrated arrangement angles but may be changed be woven at various other angles.

Meanwhile, the reinforced fibers used for preparing the multi-sheet 110 may be various kinds of fibrous reinforcements configured for forming continuous fibers such as carbon fiber, glass fiber, and aramid fiber.

The step of preparing the multi-core may be a step of rolling the multi-sheet 110 to a pipe shape having a plurality of layers. For example, the multi-core 210 may be prepared using an internal mold 10 rotated about a rotation axis. Here, as the internal mold 10, an internal mold having various shapes corresponding to a final shape of a product may be used.

For example, as illustrated in FIG. 1, a cylindrical internal mold 10 is prepared, and the prepared multi-sheet 110 is continuously wound on an external circumferential surface of the internal mold 10 to form a plurality of layers. Here, since the multi-sheet 110 is formed by continuously connecting the reinforced fiber sheets 111, 112, and 113, woven in the arrangement directions by a predetermined length, in the longitudinal direction thereof, the reinforced fiber sheet 111 woven in a predetermined arrangement direction by a predetermined length is wound around the internal mold 10 and the reinforced fiber sheets 112 and 113 subsequently woven in different arrangement directions are wound about the internal mold 10. This is repeatedly performed. Therefore, the arrangement directions of the reinforced fibers disposed in each layer forming the multi-core 210 may be adjusted by adjusting the length of each of the reinforced fiber sheets 111, 112, and 113 to correspond to the length of the external circumferential surface of the internal mold 10. For example, if the lengths of the reinforced fiber sheets 111, 112, and 113 are prepared to correspond to the length of the external circumferential surface of the internal mold, the corresponding reinforced fiber sheets 111, 112, and 113 form a layer in the multi-core 210. Also, if the lengths of the reinforced fiber sheets 111, 112, and 113 are prepared to correspond to twice of the length of the external circumferential surface of the internal mold, the corresponding reinforced fiber sheets 111, 112, and 113 form a layer in the multi-core 210. Thus, the length of each of the reinforced fiber sheets 111, 112, and 113 may be determined as a multiple length of the length of the external circumferential surface of the internal mold 10.

Meanwhile, the multi-core 210 is not limited to a single hollow portion 221 therein using the single internal mold 10 and may have various numbers of hollow portions 110a.

For example, a pair of internal molds 10 may be provided, the internal molds 10 are disposed at both end portions of the multi-sheet 110, and as such, the pair of the internal molds 10 are rolled toward a center portion of the multi-sheet 110 so that the multi-sheet 110 may be wound on an external circumferential surface of the internal mold 10 as a plurality of layers.

The step of impregnating the multi-core 210 with a resin is a step of impregnating the multi-core 210 with the resin 120 to mold a final or intermediate molded product.

Here, various resins configured for realizing a composite may be selectively used as the resin 120. For example, a thermosetting resin including a phenol resin, an epoxy resin, and the like, or thermoplastic resin including polyvinyl chloride (PVC), polyethylene (PE), polypropylene (PP), and the like, may be used.

The method of impregnating the multi-core 210 with the resin 120 may be implemented by various methods. For example, it may be implemented by disposing the multi-core 210 in a cavity formed by combining an upper mold 30a and a lower mold 30b, injecting the resin 120 into the cavity, and curing the resin 120.

As illustrated in FIG. 2, the molded product manufactured by the above manufacturing method includes the multi-core 210 formed as the multi-sheet 110 is rolled in a pipe shape having a plurality of layers, and are impregnated with a resin. Here, the resin impregnated into the multi-core 210 is referred to as a molding layer 220. The center of the multi-core 210 in which the multi-sheet 110 is rolled is implemented as the hollow portion 221. Here, the overall cross-sectional shape of the multi-core 210 is determined by the shape of the external circumferential surface of the internal mold 10, but it may be implemented as a pipe shape having a substantially circular or polygonal closed end surface. Here, in the multi-core 210, the reinforced fiber sheets 111, 112, and 113 woven in different arrangement directions are implemented as multiple layers.

In FIG. 2, for the purposes of description, the layers formed of the reinforced fiber sheets 111, 112, and 113, respectively, are expressed as concentric circles having different diameters. However, since the multi-core 210 is formed by rolling the multi-sheet 110, the multi-core 110 may be implemented as a scroll in which the layers are connected to each other in a continuous manner.

The molding layer 220 is formed by curing the resin impregnated in the multi-core 210. Here, the shape of the molding layer 220 may be variously implemented by changing the space into which the resin is injected, for example, the shape of the cavity prepared as the upper mold 30a and the lower mold 30b are combined.

The molded product manufactured by the manufacturing method as described above may be applied to parts requiring strength and rigidity while having a bar shape such as side seals, members, pillars, and the like, forming a vehicle body.

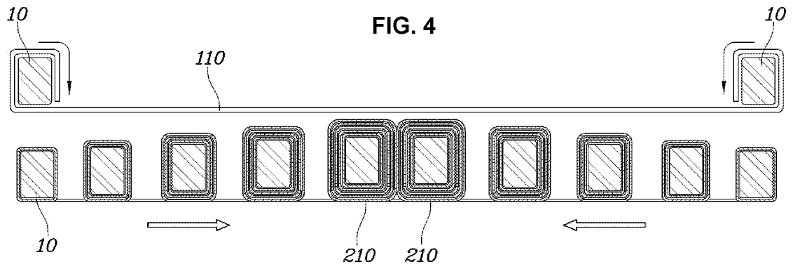

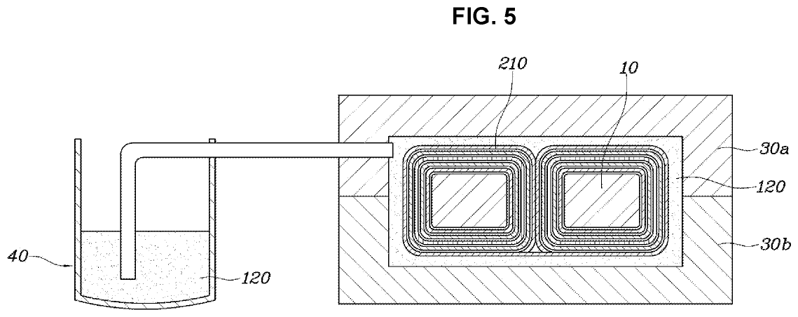

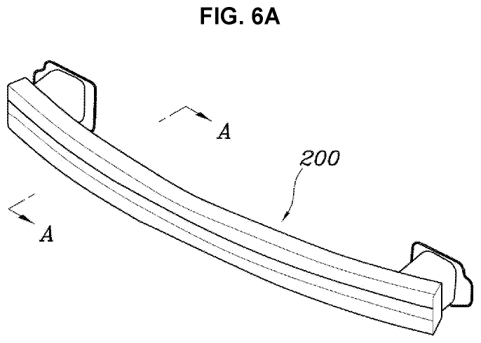

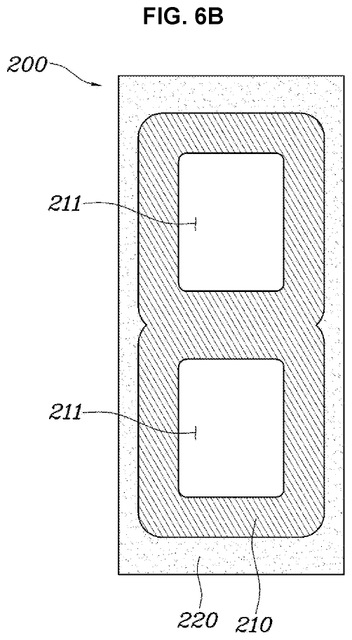

For example, FIG. 4 and FIG. 5 are views illustrating a method for manufacturing a back beam for a vehicle by a method for manufacturing a multilayer fiber reinforced resin composite according to an exemplary embodiment of the present invention. FIG. 6A is a view illustrating a back beam for a vehicle manufactured by a method for manufacturing a multilayer fiber reinforced resin composite according to an exemplary embodiment of the present invention, and FIG. 6B is a cross-sectional view taken along the line A-A of FIG. 6A.

To manufacture a back beam 200 for a vehicle, first, a multi-sheet 110 having different arrangement directions by regions in the longitudinal direction is prepared. Thereafter, the internal molds 10 are disposed at both end portions of the multi-sheet 110 as illustrated in FIG. 4. As such, the pair of internal molds 10 are rolled toward the center of the multi-sheet 110 to allow the multi-sheet 110 to be wound on the external circumferential surface of each of the internal molds 10, as a plurality of layers, to form a multi-core 210.

When the multi-core 210 is completed, the prepared multi-core 210 is placed in a cavity formed by combining the upper mold 30a and the lower mold 30b. As such, the resin 120 is injected into the cavity through a resin supply device 40 and cured. When curing of the resin is completed, a molded product is removed from the upper mold 30a and the lower mold 30b and the internal mold 10 is separated from the internal to the multi-core 210. Here, the molded product is molded into a shape corresponding to the shape of the cavity and is post-treated to be used as the back beam 200.

Here, formation of the hollow portion 211 formed inside the multi-core 210 may be determined by adjusting a timing of separating the internal mold 10. For example, if the hollow portion 211 is not formed, after the multi-core 210 is prepared using the internal mold 10, the internal mold 10 is separated from the multi-core 210 before impregnation with the resin 120, and impregnation of the resin 120 may be performed to fill the space in which the hollow portion 211 is formed with the resin 120.

Meanwhile, as illustrated in FIG. 6B, the multi-core 210 reinforcing rigidity at the center of the back beam 200 has two hollow portions 211 formed therein, and thus, since the multi-core 210 is formed to be connected continuously, strength and rigidity may be enhanced, while achieving a reduction in weight of the back beam.

According to the exemplary embodiment of the present invention, the plurality of reinforced fiber sheets, in which reinforced fibers are disposed in different arrangement directions, are sequentially disposed on the same plane in the longitudinal direction and connected to prepare the multi-sheet and the prepared multi-sheet is wound on the external circumferential surface of the internal mold, whereby a stacked structure may be realized without a stacking process. Thus, the number of processes may be reduced and the problem of dispersion in the material which may occur during the stacking process may be solved.

Furthermore, by adjusting the length of each of the reinforced fiber sheets forming the multi-sheet to correspond to the length of the external circumferential surface of the internal mold, the reinforced fiber sheet having desired arrangement directions at desired positions may be easily manufactured.

Furthermore, physical properties of the parts may be satisfied, while the parts requiring strength and rigidity, while having a bar-shaped shape such as side seals, members, pillars, and the like, forming a vehicle body, are easily manufactured.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for manufacturing a multilayer fiber reinforced resin composite, the method comprising:
preparing a multi-sheet connected by sequentially disposing and connecting a plurality of reinforced fiber sheets, in a longitudinal direction of the multi-sheet, wherein reinforced fibers of each of the plurality of reinforced fiber sheets are aligned in different directions therebetween;
rolling the multi-sheet to form a pipe-shaped multi-core having a plurality of layers; and
impregnating the pipe-shaped multi-core with a resin.

2. The method of claim 1, wherein, in the preparing of the multi-sheet, the plurality of reinforced fiber sheets is sequentially disposed in the longitudinal direction on a same plane and continuously connected.

3. The method of claim 1, wherein, in the preparing of the multi-sheet, the multi-sheet is prepared by connecting end portions of adjacent reinforced fiber sheets in which the reinforced fibers are woven in different arrangement directions.

4. The method of claim 3, wherein, in the preparing of the multi-sheet, the end portions of the adjacent reinforced fiber sheets are overlapped by a predetermined length and an overlap section of the adjacent reinforced fiber sheets is stitched to connect the end portions of the adjacent reinforced fiber sheets.

5. The method of claim 1, wherein, in the preparing of the multi-sheet, the multi-sheet is prepared by continuously weaving the reinforced fibers to have different arrangement direction by regions thereof.

6. The method of claim 5, wherein, in the preparing of the multi-sheet, the reinforced fibers are continuously woven, while changing weaving directions thereof to have different arrangement patterns by the regions using a tailored fiber placement (TFP) facility.

7. The method of claim 1, wherein, in the preparing of the pipe-shaped multi-core, the plurality of layers is formed by continuously winding the multi-sheet on an external circumferential surface of an internal mold rotating about a rotation axis of the internal mold from a first side of the multi-sheet in a direction of a second side of the multi-sheet.

8. The method of claim 7, wherein an internal to the multi-core has a hollow portion in a width direction of the multi-sheet after the internal mold is removed from the multi-sheet.

9. The method of claim 7, wherein a length of each of the reinforced fiber sheets in the preparing of the multi-sheet is determined to correspond to a perimeter of an external circumferential surface of the internal mold used in the preparing of the pipe-shaped multi-core.

10. The method of claim 8, wherein a length of each of the reinforced fiber sheets in the preparing of the multi-sheet is determined as a length of a multiple of a perimeter of an external circumferential surface of the internal mold used in the preparing of the pipe-shaped multi-core.

11. The method of claim 1, wherein, in the preparing of the pipe-shaped multi-core, the plurality of layers is formed by continuously winding the multi-sheet on an external circumferential surface of a pair of internal molds rotating about each rotation axis of the internal molds.

12. The method of claim 11, wherein an internal to the multi-core is formed of hollow portions in a width direction of the multi-sheet after the internal molds are removed from the multi-sheet.

13. The method of claim 10, wherein the preparing of the pipe-shaped multi-core further includes:
disposing the pair of the internal molds at first and second end portions of the multi-sheet, respectively; and,
after disposing the pair of the internal molds at the first and second end portions of the multi-sheet, respectively, rolling the pair of internal molds toward a center portion of the multi-sheet to allow the multi-sheet to be wound on an external circumferential surface of each of the pair of the internal molds, as a plurality of layers.

14. The method of claim 1, wherein the impregnating includes disposing the pipe-shaped multi-core in a cavity prepared by combining an upper mold and a lower mold and injecting the resin into the cavity to impregnate the pipe-shaped multi-core with the resin.

15. A molded product comprising:
a multi-core formed by rolling a multi-sheet, which is formed by sequentially disposing and continuously connecting a plurality of reinforced fiber sheets, in a longitudinal direction of the multi-sheet, in a pipe shape having a plurality of layers,
wherein reinforced fibers of each of the plurality of reinforced fiber sheets are aligned in different directions therebetween, and
wherein the multi-core is impregnated with a resin.

16. The molded product of claim 15, wherein the multi-core is formed by rolling an end portion of the multi-core from a first side of the multi-sheet in a direction of a second side of the multi-sheet in a pipe shape.

17. The molded product of claim 16, wherein an internal to the multi-core has a hollow portion in a width direction of the multi-sheet.

18. The molded product of claim 15, wherein the multi-core includes a pair of continued roll portions formed by rolling the multi-sheet from first and second end portions of the multi-sheet in a direction toward a center portion of the multi-sheet.

19. The molded product of claim 18, wherein an internal to the multi-core has a hollow portion in a width direction of the multi-sheet.
